(19) United States
(12) Patent Application Publication
(10) Pub. No.: US 2024/0256909 A1
(43) Pub. Date: Aug. 1, 2024

(54) TECHNOLOGIES FOR IMPLICIT FEEDBACK USING MULTI-FACTOR BEHAVIOR MONITORING

(71) Applicant: Genesys Cloud Services, Inc., Menlo Park, CA (US)

(72) Inventors: Stéphane Blécon, Guipavas (FR); Benjamin Bernard, Guipavas (FR)

(21) Appl. No.: 18/104,118

(22) Filed: Jan. 31, 2023

(51) Int. Cl. G06N 5/022

(52) U.S. Cl. CPC G06N 5/022

(57) ABSTRACT

A method of providing implicit feedback using multi-factor behavior monitoring according to an embodiment includes receiving, by a computing system, a transcript of a conversation between an agent and a user, providing, by the computing system, at least one suggestion to the agent via an agent application based on the transcript of the conversation between the agent and the user, evaluating, by the computing system, data indicative of behaviors of the agent with respect to the at least one suggestion using machine learning, and updating, by the computing system, a knowledge base model based on the evaluation of the data indicative of behaviors of the agent with respect to the at least one suggestion using machine learning.

### BACKGROUND

Call centers and other contact centers are used by many organizations to provide technical and other support to their end users. The end user may interact with human and/or virtual agents of the contact center by establishing electronic communications via one or more communication technologies including, for example, telephone, email, web chat, Short Message Service (SMS), dedicated software application(s), and/or other technologies. Contact center agents may rely on knowledge bases and/or other resources in order to answer questions posed by end users.

### SUMMARY

One embodiment is directed to a unique system, components, and methods for providing implicit feedback using multi-factor behavior monitoring. Other embodiments are directed to apparatuses, systems, devices, hardware, methods, and combinations thereof for providing implicit feedback using multi-factor behavior monitoring.

According to an embodiment, a system for providing implicit feedback using multi-factor behavior monitoring may include a computing system comprising at least one first processor and at least one first memory having a first plurality of instructions stored thereon that, in response to execution by the at least one first processor, causes the computing system to receive a transcript of a conversation between an agent and a user, provide at least one suggestion to the agent via an agent application based on the transcript of the conversation between the agent and the user, evaluate data indicative of behaviors of the agent with respect to the at least one suggestion using machine learning, and update a knowledge base model based on the evaluation of the data indicative of behaviors of the agent with respect to the at least one suggestion using machine learning.

In some embodiments, the first plurality of instructions may further cause the computing system to analyze the transcript of the conversation between the agent and the user to find suggestion content related to the transcript, and to provide the at least one suggestion to the agent may include to provide at least one suggestion to the agent that references the suggestion content related to the transcript.

In some embodiments, the system may further include an agent device having a display, at least one second processor, and at least one second memory having a second plurality of instructions stored thereon that, in response to execution by the at least one second processor, causes the agent device to execute the agent application to present the at least one suggestion to the agent on the display via a graphical user interface.

In some embodiments, the second plurality of instructions may further cause the agent device to monitor agent interactions with the agent application.

In some embodiments, the agent interactions may comprise one or more user interactions with elements of the graphical user interface.

In some embodiments, to evaluate the data indicative of behaviors of the agent with respect to the at least one suggestion using machine learning may include to evaluate times at which the at least one suggestion were displayed and times of the agent interactions with the agent application.

In some embodiments, to update the knowledge base model based on the evaluation of the data indicative of behaviors of the agents with respect to the at least one suggestion using machine learning may include to rank each of the at least one suggestion.

In some embodiments, to receive the transcript of the conversation between the agent and the user may include to receive transcribed messages of the conversation between the agent and the user in real time.

According to another embodiment, a method of providing implicit feedback using multi-factor behavior monitoring may include receiving, by a computing system, a transcript of a conversation between an agent and a user, providing, by the computing system, at least one suggestion to the agent via an agent application based on the transcript of the conversation between the agent and the user, evaluating, by the computing system, data indicative of behaviors of the agent with respect to the at least one suggestion using machine learning, and updating, by the computing system, a knowledge base model based on the evaluation of the data indicative of behaviors of the agent with respect to the at least one suggestion using machine learning.

In some embodiments, the method may further include analyzing the transcript of the conversation between the agent and the user to find suggestion content related to the transcript, and providing the at least one suggestion to the agent may include providing at least one suggestion to the agent that references the suggestion content related to the transcript.

In some embodiments, the agent application may be executed by an agent device of the agent, and the method may further include presenting the at least one suggestion to the agent via a graphical user interface displayed on the agent device via the agent application.

In some embodiments, the method may further include monitoring agent interactions with the agent application.

In some embodiments, the agent interactions may include one or more user interactions with elements of the graphical user interface.

In some embodiments, evaluating the data indicative of behaviors of the agent with respect to the at least one suggestion using machine learning may include evaluating times at which the at least one suggestion were displayed on the agent device and times of the agent interactions with the agent application.

In some embodiments, updating the knowledge base model based on the evaluation of the data indicative of behaviors of the agents with respect to the at least one suggestion using machine learning may include ranking each of the at least one suggestion.

In some embodiments, receiving the transcript of the conversation between the agent and the user may include receiving transcribed messages of the conversation between the agent and the user in real time.

According to yet another embodiment, one or more non-transitory machine readable storage media may include a plurality of instructions stored thereon that, in response to execution by a system, causes the system to receive a transcript of a conversation between an agent and a user, provide at least one suggestion to the agent via an agent application based on the transcript of the conversation between the agent and the user, evaluate data indicative of behaviors of the agent with respect to the at least one suggestion using machine learning, and update a knowledge base model based on the evaluation of the data indicative of behaviors of the agent with respect to the at least one suggestion using machine learning.

In some embodiments, the plurality of instructions may further cause the system to analyze the transcript of the conversation between the agent and the user to find suggestion content related to the transcript, and to provide the at least one suggestion to the agent may include to provide at least one suggestion to the agent that references the suggestion content related to the transcript.

In some embodiments, to evaluate the data indicative of behaviors of the agent with respect to the at least one suggestion using machine learning may include to evaluate times at which the at least one suggestion were displayed on an agent device and times of the agent interactions with the agent application.

In some embodiments, to receive the transcript of the conversation between the agent and the user may include to receive transcribed messages of the conversation between the agent and the user in real time.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a simplified block diagram of at least one embodiment of a contact center system;

FIG. 2 is a simplified block diagram of at least one embodiment of a computing device;

FIG. 3 is a simplified flow diagram of at least one embodiment of a method of providing implicit feedback using multi-factor behavior monitoring;

FIG. 4 is a simplified system flow illustrating at least one embodiment of a system and method for providing implicit feedback using multi-factor behavior monitoring;

FIG. 5 is a simplified flow diagram of at least one embodiment of a method of providing implicit feedback using multi-factor behavior monitoring; and

FIG. 6 is a simplified graphical user interface of an agent application for interacting with a user.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

As described in greater detail below, it should be appreciated that the technologies described herein provide for implicit feedback using multi-factor behavior monitoring of agent activity during interactions with users. In particular, a computing system may use a live agent interaction transcript to identify displayed content that is used (or not used) and provide automatic feedback regarding the relevance, efficacy, impact, and/or other characteristics of the displayed suggestions. Rather than relying on buttons that require manual action, the technologies described herein allow for autonomous feedback based on an analysis of the conversation between the agent and the user and monitoring of the agent's behavior during the user interaction. As such, no independent manual operations are needed from the agent to provide suggestion feedback which consumes agent time, and the knowledge base suggestions are proactively improved by updating the suggestions based on agent use of the suggestions. For example, machine learning may be used to analyze the data and improve the suggestion rankings for subsequent use (e.g., thereby reducing the number of suggestions presented to agents in the future).

It should be appreciated that the technologies described herein address various objectives of relevant actors (e.g., the user, agent, and knowledge base manager) involved in contact center communications. For example, the user may want to ask questions with the expectation that they will be answered accurately and promptly. The agent may want contextual help from an automated knowledge base, and to be able to speak/reply using displayed agent assist suggestions with automatic feedback based on the agent's answers (e.g., without the agent expressly providing feedback). The knowledge base manager may want to see relevant answers, identify incorrect suggestions, maximize feedback received, and analyze how suggestions are used by agents.

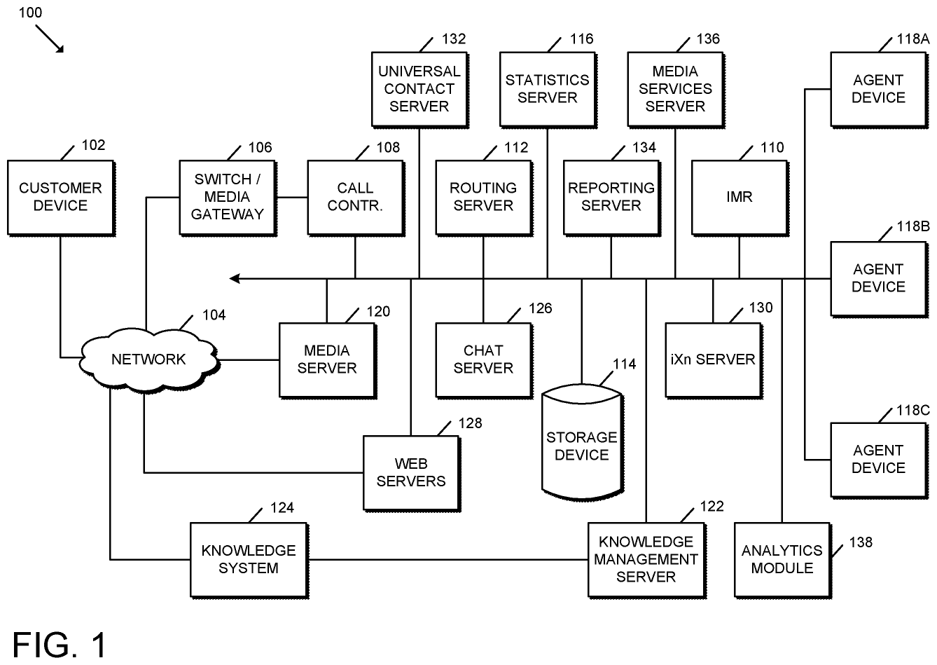

Referring now to FIG. 1, a simplified block diagram of at least one embodiment of a communications infrastructure and/or contact center system, which may be used in conjunction with one or more of the embodiments described herein, is shown. The contact center system 100 may be embodied as any system capable of providing contact center services (e.g., call center services, chat center services, SMS center services, etc.) to an end user and otherwise performing the functions described herein. The illustrative contact center system 100 includes a customer device 102, a network 104, a switch/media gateway 106, a call controller 108, an interactive media response (IMIR) server 110, a routing server 112, a storage device 114, a statistics server 116, agent devices 118A, 118B, 118C, a media server 120, a knowledge management server 122, a knowledge system 124, chat server 126, web servers 128, an interaction (iXn) server 130, a universal contact server 132, a reporting server 134, a media services server 136, and an analytics module 138. Although only one customer device 102, one network 104, one switch/media gateway 106, one call controller 108, one IM R server 110, one routing server 112, one storage device 114, one statistics server 116, one media server 120, one knowledge management server 122, one knowledge system 124, one chat server 126, one iXn server 130, one universal contact server 132, one reporting server 134, one media services server 136, and one analytics module 138 are shown in the illustrative embodiment of FIG. 1, the contact center system 100 may include multiple customer devices 102, networks 104, switch/media gateways 106, call controllers 108, IMR servers 110, routing servers 112, storage devices 114, statistics servers 116, media servers 120, knowledge management servers 122, knowledge systems 124, chat servers 126, iXn servers 130, universal contact servers 132, reporting servers 134, media services servers 136, and/or analytics modules 138 in other embodiments. Further, in some embodiments, one or more of the components described herein may be excluded from the system 100, one or more of the components described as being independent may form a portion of another component, and/or one or more of the component described as forming a portion of another component may be independent.

It should be understood that the term “contact center system” is used herein to refer to the system depicted in FIG. 1 and/or the components thereof, while the term “contact center” is used more generally to refer to contact center systems, customer service providers operating those systems, and/or the organizations or enterprises associated therewith. Thus, unless otherwise specifically limited, the term “contact center” refers generally to a contact center system (such as the contact center system 100), the associated customer service provider (such as a particular customer service provider/agent providing customer services through the contact center system 100), as well as the organization or enterprise on behalf of which those customer services are being provided.

By way of background, customer service providers may offer many types of services through contact centers. Such contact centers may be staffed with employees or customer service agents (or simply “agents”), with the agents serving as an interface between a company, enterprise, government agency, or organization (hereinafter referred to interchangeably as an “organization” or “enterprise”) and persons, such as users, individuals, or customers (hereinafter referred to interchangeably as “individuals,” “customers,” or “contact center clients”). For example, the agents at a contact center may assist customers in making purchasing decisions, receiving orders, or solving problems with products or services already received. Within a contact center, such interactions between contact center agents and outside entities or customers may be conducted over a variety of communication channels, such as, for example, via voice (e.g., telephone calls or voice over IP or VoIP calls), video (e.g., video conferencing), text (e.g., emails and text chat), screen sharing, co-browsing, and/or other communication channels.

Operationally, contact centers generally strive to provide quality services to customers while minimizing costs. For example, one way for a contact center to operate is to handle every customer interaction with a live agent. While this approach may score well in terms of the service quality, it likely would also be prohibitively expensive due to the high cost of agent labor. Because of this, most contact centers utilize some level of automated processes in place of live agents, such as, for example, interactive voice response (IVR) systems, interactive media response (IMR) systems, internet robots or “bots”, automated chat modules or “chatbots”, and/or other automated processed. In many cases, this has proven to be a successful strategy, as automated processes can be highly efficient in handling certain types of interactions and effective at decreasing the need for live agents. Such automation allows contact centers to target the use of human agents for the more difficult customer interactions, while the automated processes handle the more repetitive or routine tasks. Further, automated processes can be structured in a way that optimizes efficiency and promotes repeatability. Whereas a human or live agent may forget to ask certain questions or follow-up on particular details, such mistakes are typically avoided through the use of automated processes. While customer service providers are increasingly relying on automated processes to interact with customers, the use of such technologies by customers remains far less developed. Thus, while IVR systems, IMR systems, and/or bots are used to automate portions of the interaction on the contact center-side of an interaction, the actions on the customer-side remain for the customer to perform manually.

It should be appreciated that the contact center system 100 may be used by a customer service provider to provide various types of services to customers. For example, the contact center system 100 may be used to engage and manage interactions in which automated processes (or bots) or human agents communicate with customers. As should be understood, the contact center system 100 may be an in-house facility to a business or enterprise for performing the functions of sales and customer service relative to products and services available through the enterprise. In another embodiment, the contact center system 100 may be operated by a third-party service provider that contracts to provide services for another organization. Further, the contact center system 100 may be deployed on equipment dedicated to the enterprise or third-party service provider, and/or deployed in a remote computing environment such as, for example, a private or public cloud environment with infrastructure for supporting multiple contact centers for multiple enterprises. The contact center system 100 may include software applications or programs, which may be executed on premises or remotely or some combination thereof. It should further be appreciated that the various components of the contact center system 100 may be distributed across various geographic locations and not necessarily contained in a single location or computing environment.

It should further be understood that, unless otherwise specifically limited, any of the computing elements of the present invention may be implemented in cloud-based or cloud computing environments. As used herein and further described below in reference to the computing device 200, “cloud computing”—or, simply, the “cloud”—is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. Cloud computing can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Often referred to as a “serverless architecture,” a cloud execution model generally includes a service provider dynamically managing an allocation and provisioning of remote servers for achieving a desired functionality.

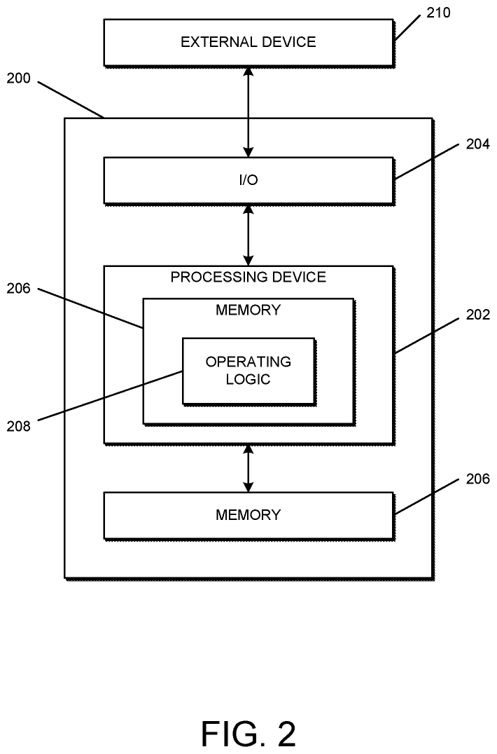

It should be understood that any of the computer-implemented components, modules, or servers described in relation to FIG. 1 may be implemented via one or more types of computing devices, such as, for example, the computing device 200 of FIG. 2. As will be seen, the contact center system 100 generally manages resources (e.g., personnel, computers, telecommunication equipment, etc.) to enable delivery of services via telephone, email, chat, or other communication mechanisms. Such services may vary depending on the type of contact center and, for example, may include customer service, help desk functionality, emergency response, telemarketing, order taking, and/or other characteristics.

Customers desiring to receive services from the contact center system 100 may initiate inbound communications (e.g., telephone calls, emails, chats, etc.) to the contact center system 100 via a customer device 102. While FIG. 1 shows one such customer device—i.e., customer device 102—it should be understood that any number of customer devices 102 may be present. The customer devices 102, for example, may be a communication device, such as a telephone, smart phone, computer, tablet, or laptop. In accordance with functionality described herein, customers may generally use the customer devices 102 to initiate, manage, and conduct communications with the contact center system 100, such as telephone calls, emails, chats, text messages, web-browsing sessions, and other multi-media transactions.

Inbound and outbound communications from and to the customer devices 102 may traverse the network 104, with the nature of the network typically depending on the type of customer device being used and the form of communication. As an example, the network 104 may include a communication network of telephone, cellular, and/or data services. The network 104 may be a private or public switched telephone network (PSTN), local area network (LAN), private wide area network (WAN), and/or public WAN such as the Internet. Further, the network 104 may include a wireless carrier network including a code division multiple access (CDMA) network, global system for mobile communications (GSM) network, or any wireless network/technology conventional in the art, including but not limited to 3G, 4G, LTE, 5G, etc.

The switch/media gateway 106 may be coupled to the network 104 for receiving and transmitting telephone calls between customers and the contact center system 100. The switch/media gateway 106 may include a telephone or communication switch configured to function as a central switch for agent level routing within the center. The switch may be a hardware switching system or implemented via software. For example, the switch 106 may include an automatic call distributor, a private branch exchange (PBX), an IP-based software switch, and/or any other switch with specialized hardware and software configured to receive Internet-sourced interactions and/or telephone network-sourced interactions from a customer, and route those interactions to, for example, one of the agent devices 118. Thus, in general, the switch/media gateway 106 establishes a voice connection between the customer and the agent by establishing a connection between the customer device 102 and agent device 118.

As further shown, the switch/media gateway 106 may be coupled to the call controller 108 which, for example, serves as an adapter or interface between the switch and the other routing, monitoring, and communication-handling components of the contact center system 100. The call controller 108 may be configured to process PSTN calls, VoIP calls, and/or other types of calls. For example, the call controller 108 may include computer-telephone integration (CTI) software for interfacing with the switch/media gateway and other components. The call controller 108 may include a session initiation protocol (SIP) server for processing SIP calls. The call controller 108 may also extract data about an incoming interaction, such as the customer's telephone number, IP address, or email address, and then communicate these with other contact center components in processing the interaction.

The interactive media response (IMR) server 110 may be configured to enable self-help or virtual assistant functionality. Specifically, the IMR server 110 may be similar to an interactive voice response (IVR) server, except that the IMR server 110 is not restricted to voice and may also cover a variety of media channels. In an example illustrating voice, the IMR server 110 may be configured with an IMR script for querying customers on their needs. For example, a contact center for a bank may instruct customers via the IMR script to “press 1” if they wish to retrieve their account balance. Through continued interaction with the IMR server 110, customers may receive service without needing to speak with an agent. The IMR server 110 may also be configured to ascertain why a customer is contacting the contact center so that the communication may be routed to the appropriate resource. The IMR configuration may be performed through the use of a self-service and/or assisted service tool which comprises a web-based tool for developing IVR applications and routing applications running in the contact center environment.

The routing server 112 may function to route incoming interactions. For example, once it is determined that an inbound communication should be handled by a human agent, functionality within the routing server 112 may select the most appropriate agent and route the communication thereto. This agent selection may be based on which available agent is best suited for handling the communication. More specifically, the selection of appropriate agent may be based on a routing strategy or algorithm that is implemented by the routing server 112. In doing this, the routing server 112 may query data that is relevant to the incoming interaction, for example, data relating to the particular customer, available agents, and the type of interaction, which, as described herein, may be stored in particular databases. Once the agent is selected, the routing server 112 may interact with the call controller 108 to route (i.e., connect) the incoming interaction to the corresponding agent device 118. As part of this connection, information about the customer may be provided to the selected agent via their agent device 118. This information is intended to enhance the service the agent is able to provide to the customer.

It should be appreciated that the contact center system 100 may include one or more mass storage devices—represented generally by the storage device 114—for storing data in one or more databases relevant to the functioning of the contact center. For example, the storage device 114 may store customer data that is maintained in a customer database. Such customer data may include, for example, customer profiles, contact information, service level agreement (SLA), and interaction history (e.g., details of previous interactions with a particular customer, including the nature of previous interactions, disposition data, wait time, handle time, and actions taken by the contact center to resolve customer issues). As another example, the storage device 114 may store agent data in an agent database. Agent data maintained by the contact center system 100 may include, for example, agent availability and agent profiles, schedules, skills, handle time, and/or other relevant data. As another example, the storage device 114 may store interaction data in an interaction database. Interaction data may include, for example, data relating to numerous past interactions between customers and contact centers. More generally, it should be understood that, unless otherwise specified, the storage device 114 may be configured to include databases and/or store data related to any of the types of information described herein, with those databases and/or data being accessible to the other modules or servers of the contact center system 100 in ways that facilitate the functionality described herein. For example, the servers or modules of the contact center system 100 may query such databases to retrieve data stored therein or transmit data thereto for storage. The storage device 114, for example, may take the form of any conventional storage medium and may be locally housed or operated from a remote location. As an example, the databases may be Cassandra database, NoSQL database, or a SQL database and managed by a database management system, such as, Oracle, IBM DB2, Microsoft SQL server, or Microsoft Access, PostgreSQL.

The statistics server 116 may be configured to record and aggregate data relating to the performance and operational aspects of the contact center system 100. Such information may be compiled by the statistics server 116 and made available to other servers and modules, such as the reporting server 134, which then may use the data to produce reports that are used to manage operational aspects of the contact center and execute automated actions in accordance with functionality described herein. Such data may relate to the state of contact center resources, e.g., average wait time, abandonment rate, agent occupancy, and others as functionality described herein would require.

The agent devices 118 of the contact center system 100 may be communication devices configured to interact with the various components and modules of the contact center system 100 in ways that facilitate functionality described herein. An agent device 118, for example, may include a telephone adapted for regular telephone calls or VoIP calls. An agent device 118 may further include a computing device configured to communicate with the servers of the contact center system 100, perform data processing associated with operations, and interface with customers via voice, chat, email, and other multimedia communication mechanisms according to functionality described herein. Although FIG. 1 shows three such agent devices 118—i.e., agent devices 118A, 118B and 118C—it should be understood that any number of agent devices 118 may be present in a particular embodiment.

The multimedia/social media server 120 may be configured to facilitate media interactions (other than voice) with the customer devices 102 and/or the servers 128. Such media interactions may be related, for example, to email, voice mail, chat, video, text-messaging, web, social media, co-browsing, etc. The multimedia/social media server 120 may take the form of any IP router conventional in the art with specialized hardware and software for receiving, processing, and forwarding multi-media events and communications.

The knowledge management server 122 may be configured to facilitate interactions between customers and the knowledge system 124. In general, the knowledge system 124 may be a computer system capable of receiving questions or queries and providing answers in response. The knowledge system 124 may be included as part of the contact center system 100 or operated remotely by a third party. The knowledge system 124 may include an artificially intelligent computer system capable of answering questions posed in natural language by retrieving information from information sources such as encyclopedias, dictionaries, newswire articles, literary works, or other documents submitted to the knowledge system 124 as reference materials. As an example, the knowledge system 124 may be embodied as IBM Watson or a similar system.

The chat server 126, it may be configured to conduct, orchestrate, and manage electronic chat communications with customers. In general, the chat server 126 is configured to implement and maintain chat conversations and generate chat transcripts. Such chat communications may be conducted by the chat server 126 in such a way that a customer communicates with automated chatbots, human agents, or both. In exemplary embodiments, the chat server 126 may perform as a chat orchestration server that dispatches chat conversations among the chatbots and available human agents. In such cases, the processing logic of the chat server 126 may be rules driven so to leverage an intelligent workload distribution among available chat resources. The chat server 126 further may implement, manage, and facilitate user interfaces (UIs) associated with the chat feature, including those UIs generated at either the customer device 102 or the agent device 118. The chat server 126 may be configured to transfer chats within a single chat session with a particular customer between automated and human sources such that, for example, a chat session transfers from a chatbot to a human agent or from a human agent to a chatbot. The chat server 126 may also be coupled to the knowledge management server 122 and the knowledge systems 124 for receiving suggestions and answers to queries posed by customers during a chat so that, for example, links to relevant articles can be provided.

The web servers 128 may be included to provide site hosts for a variety of social interaction sites to which customers subscribe, such as Facebook, Twitter, Instagram, etc. Though depicted as part of the contact center system 100, it should be understood that the web servers 128 may be provided by third parties and/or maintained remotely. The web servers 128 may also provide webpages for the enterprise or organization being supported by the contact center system 100. For example, customers may browse the webpages and receive information about the products and services of a particular enterprise. Within such enterprise webpages, mechanisms may be provided for initiating an interaction with the contact center system 100, for example, via web chat, voice, or email. An example of such a mechanism is a widget, which can be deployed on the webpages or websites hosted on the web servers 128. As used herein, a widget refers to a user interface component that performs a particular function. In some implementations, a widget may include a graphical user interface control that can be overlaid on a webpage displayed to a customer via the Internet. The widget may show information, such as in a window or text box, or include buttons or other controls that allow the customer to access certain functionalities, such as sharing or opening a file or initiating a communication. In some implementations, a widget includes a user interface component having a portable portion of code that can be installed and executed within a separate webpage without compilation. Some widgets can include corresponding or additional user interfaces and be configured to access a variety of local resources (e.g., a calendar or contact information on the customer device) or remote resources via network (e.g., instant messaging, electronic mail, or social networking updates).

The interaction (iXn) server 130 may be configured to manage deferrable activities of the contact center and the routing thereof to human agents for completion. As used herein, deferrable activities may include back-office work that can be performed off-line, e.g., responding to emails, attending training, and other activities that do not entail real-time communication with a customer. As an example, the interaction (iXn) server 130 may be configured to interact with the routing server 112 for selecting an appropriate agent to handle each of the deferrable activities. Once assigned to a particular agent, the deferrable activity is pushed to that agent so that it appears on the agent device 118 of the selected agent. The deferrable activity may appear in a workbin as a task for the selected agent to complete. The functionality of the workbin may be implemented via any conventional data structure, such as, for example, a linked list, array, and/or other suitable data structure. Each of the agent devices 118 may include a workbin. As an example, a workbin may be maintained in the buffer memory of the corresponding agent device 118.

The universal contact server (UCS) 132 may be configured to retrieve information stored in the customer database and/or transmit information thereto for storage therein. For example, the UCS 132 may be utilized as part of the chat feature to facilitate maintaining a history on how chats with a particular customer were handled, which then may be used as a reference for how future chats should be handled. More generally, the UCS 132 may be configured to facilitate maintaining a history of customer preferences, such as preferred media channels and best times to contact. To do this, the UCS 132 may be configured to identify data pertinent to the interaction history for each customer such as, for example, data related to comments from agents, customer communication history, and the like. Each of these data types then may be stored in the customer database 222 or on other modules and retrieved as functionality described herein requires.

The reporting server 134 may be configured to generate reports from data compiled and aggregated by the statistics server 116 or other sources. Such reports may include near real-time reports or historical reports and concern the state of contact center resources and performance characteristics, such as, for example, average wait time, abandonment rate, and/or agent occupancy. The reports may be generated automatically or in response to specific requests from a requestor (e.g., agent, administrator, contact center application, etc.). The reports then may be used toward managing the contact center operations in accordance with functionality described herein.

The media services server 136 may be configured to provide audio and/or video services to support contact center features. In accordance with functionality described herein, such features may include prompts for an IVR or IMR system (e.g., playback of audio files), hold music, voicemails/single party recordings, multi-party recordings (e.g., of audio and/or video calls), screen recording, speech recognition, dual tone multi frequency (DTMF) recognition, faxes, audio and video transcoding, secure real-time transport protocol (SRTP), audio conferencing, video conferencing, coaching (e.g., support for a coach to listen in on an interaction between a customer and an agent and for the coach to provide comments to the agent without the customer hearing the comments), call analysis, keyword spotting, and/or other relevant features.

The analytics module 138 may be configured to provide systems and methods for performing analytics on data received from a plurality of different data sources as functionality described herein may require. In accordance with example embodiments, the analytics module 138 also may generate, update, train, and modify predictors or models based on collected data, such as, for example, customer data, agent data, and interaction data. The models may include behavior models of customers or agents. The behavior models may be used to predict behaviors of, for example, customers or agents, in a variety of situations, thereby allowing embodiments of the present invention to tailor interactions based on such predictions or to allocate resources in preparation for predicted characteristics of future interactions, thereby improving overall contact center performance and the customer experience. It will be appreciated that, while the analytics module is described as being part of a contact center, such behavior models also may be implemented on customer systems (or, as also used herein, on the “customer-side” of the interaction) and used for the benefit of customers.

According to exemplary embodiments, the analytics module 138 may have access to the data stored in the storage device 114, including the customer database and agent database. The analytics module 138 also may have access to the interaction database, which stores data related to interactions and interaction content (e.g., transcripts of the interactions and events detected therein), interaction metadata (e.g., customer identifier, agent identifier, medium of interaction, length of interaction, interaction start and end time, department, tagged categories), and the application setting (e.g., the interaction path through the contact center). Further, the analytic module 138 may be configured to retrieve data stored within the storage device 114 for use in developing and training algorithms and models, for example, by applying machine learning techniques.

One or more of the included models may be configured to predict customer or agent behavior and/or aspects related to contact center operation and performance. Further, one or more of the models may be used in natural language processing and, for example, include intent recognition and the like. The models may be developed based upon known first principle equations describing a system; data, resulting in an empirical model; or a combination of known first principle equations and data. In developing a model for use with present embodiments, because first principles equations are often not available or easily derived, it may be generally preferred to build an empirical model based upon collected and stored data. To properly capture the relationship between the manipulated/disturbance variables and the controlled variables of complex systems, in some embodiments, it may be preferable that the models are nonlinear. This is because nonlinear models can represent curved rather than straight-line relationships between manipulated/disturbance variables and controlled variables, which are common to complex systems such as those discussed herein. Given the foregoing requirements, a machine learning or neural network-based approach may be a preferred embodiment for implementing the models. Neural networks, for example, may be developed based upon empirical data using advanced regression algorithms.

The analytics module 138 may further include an optimizer. As will be appreciated, an optimizer may be used to minimize a “cost function” subject to a set of constraints, where the cost function is a mathematical representation of desired objectives or system operation. Because the models may be non-linear, the optimizer may be a nonlinear programming optimizer. It is contemplated, however, that the technologies described herein may be implemented by using, individually or in combination, a variety of different types of optimization approaches, including, but not limited to, linear programming, quadratic programming, mixed integer non-linear programming, stochastic programming, global non-linear programming, genetic algorithms, particle/swarm techniques, and the like.

According to some embodiments, the models and the optimizer may together be used within an optimization system. For example, the analytics module 138 may utilize the optimization system as part of an optimization process by which aspects of contact center performance and operation are optimized or, at least, enhanced. This, for example, may include features related to the customer experience, agent experience, interaction routing, natural language processing, intent recognition, or other functionality related to automated processes.

The various components, modules, and/or servers of FIG. 1 (as well as the other figures included herein) may each include one or more processors executing computer program instructions and interacting with other system components for performing the various functionalities described herein. Such computer program instructions may be stored in a memory implemented using a standard memory device, such as, for example, a random-access memory (RAM), or stored in other non-transitory computer readable media such as, for example, a CD-ROM, flash drive, etc. Although the functionality of each of the servers is described as being provided by the particular server, a person of skill in the art should recognize that the functionality of various servers may be combined or integrated into a single server, or the functionality of a particular server may be distributed across one or more other servers without departing from the scope of the present invention. Further, the terms “interaction” and “communication” are used interchangeably, and generally refer to any real-time and non-real-time interaction that uses any communication channel including, without limitation, telephone calls (PSTN or VoIP calls), emails, vmails, video, chat, screen-sharing, text messages, social media messages, WebRTC calls, etc. Access to and control of the components of the contact center system 100 may be affected through user interfaces (UIs) which may be generated on the customer devices 102 and/or the agent devices 118.

As noted above, in some embodiments, the contact center system 100 may operate as a hybrid system in which some or all components are hosted remotely, such as in a cloud-based or cloud computing environment. It should be appreciated that each of the devices of the contact center system 100 may be embodied as, include, or form a portion of one or more computing devices similar to the computing device 200 described below in reference to FIG. 2.

Referring now to FIG. 2, a simplified block diagram of at least one embodiment of a computing device 200 is shown. The illustrative computing device 200 depicts at least one embodiment of each of the computing devices, systems, servicers, controllers, switches, gateways, engines, modules, and/or computing components described herein (e.g., which collectively may be referred to interchangeably as computing devices, servers, or modules for brevity of the description). For example, the various computing devices may be a process or thread running on one or more processors of one or more computing devices 200, which may be executing computer program instructions and interacting with other system modules in order to perform the various functionalities described herein. Unless otherwise specifically limited, the functionality described in relation to a plurality of computing devices may be integrated into a single computing device, or the various functionalities described in relation to a single computing device may be distributed across several computing devices. Further, in relation to the computing systems described herein-such as the contact center system 100 of FIG. 1—the various servers and computer devices thereof may be located on local computing devices 200 (e.g., on-site at the same physical location as the agents of the contact center), remote computing devices 200 (e.g., off-site or in a cloud-based or cloud computing environment, for example, in a remote data center connected via a network), or some combination thereof. In some embodiments, functionality provided by servers located on computing devices off-site may be accessed and provided over a virtual private network (VPN), as if such servers were on-site, or the functionality may be provided using a software as a service (SaaS) accessed over the Internet using various protocols, such as by exchanging data via extensible markup language (XML), JSON, and/or the functionality may be otherwise accessed/leveraged.

In some embodiments, the computing device 200 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry of the computing device 200 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as one or more of the devices/systems described herein, and/or a portion thereof. Further, in some embodiments, the external device 210 may be embodied as another computing device, switch, diagnostic tool, controller, printer, display, alarm, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), graphics processing unit (GPU), field-programmable gate array (FPGA), application-specific integrated circuit (ASIC), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is programmable and executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable type, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

The computing device 200 may be one of a plurality of devices connected by a network or connected to other systems/resources via a network. The network may be embodied as any one or more types of communication networks that are capable of facilitating communication between the various devices communicatively connected via the network. As such, the network may include one or more networks, routers, switches, access points, hubs, computers, client devices, endpoints, nodes, and/or other intervening network devices. For example, the network may be embodied as or otherwise include one or more cellular networks, telephone networks, local or wide area networks, publicly available global networks (e.g., the Internet), ad hoc networks, short-range communication links, or a combination thereof. In some embodiments, the network may include a circuit-switched voice or data network, a packet-switched voice or data network, and/or any other network able to carry voice and/or data. In particular, in some embodiments, the network may include Internet Protocol (TP)-based and/or asynchronous transfer mode (ATM)-based networks. In some embodiments, the network may handle voice traffic (e.g., via a Voice over IP (VOIP) network), web traffic, and/or other network traffic depending on the particular embodiment and/or devices of the system in communication with one another. In various embodiments, the network may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. It should be appreciated that the various devices/systems may communicate with one another via different networks depending on the source and/or destination devices/systems.

It should be appreciated that the computing device 200 may communicate with other computing devices 200 via any type of gateway or tunneling protocol such as secure socket layer or transport layer security. The network interface may include a built-in network adapter, such as a network interface card, suitable for interfacing the computing device to any type of network capable of performing the operations described herein. Further, the network environment may be a virtual network environment where the various network components are virtualized. For example, the various machines may be virtual machines implemented as a software-based computer running on a physical machine. The virtual machines may share the same operating system, or, in other embodiments, different operating system may be run on each virtual machine instance. For example, a “hypervisor” type of virtualizing is used where multiple virtual machines run on the same host physical machine, each acting as if it has its own dedicated box. Other types of virtualization may be employed in other embodiments, such as, for example, the network (e.g., via software defined networking) or functions (e.g., via network functions virtualization).

Accordingly, one or more of the computing devices 200 described herein may be embodied as, or form a portion of, one or more cloud-based systems. In cloud-based embodiments, the cloud-based system may be embodied as a server-ambiguous computing solution, for example, that executes a plurality of instructions on-demand, contains logic to execute instructions only when prompted by a particular activity/trigger, and does not consume computing resources when not in use. That is, system may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system described herein. For example, when an event occurs (e.g., data is transferred to the system for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system), the appropriate virtual function(s) may be executed to perform the actions before eliminating the instance of the virtual function(s).

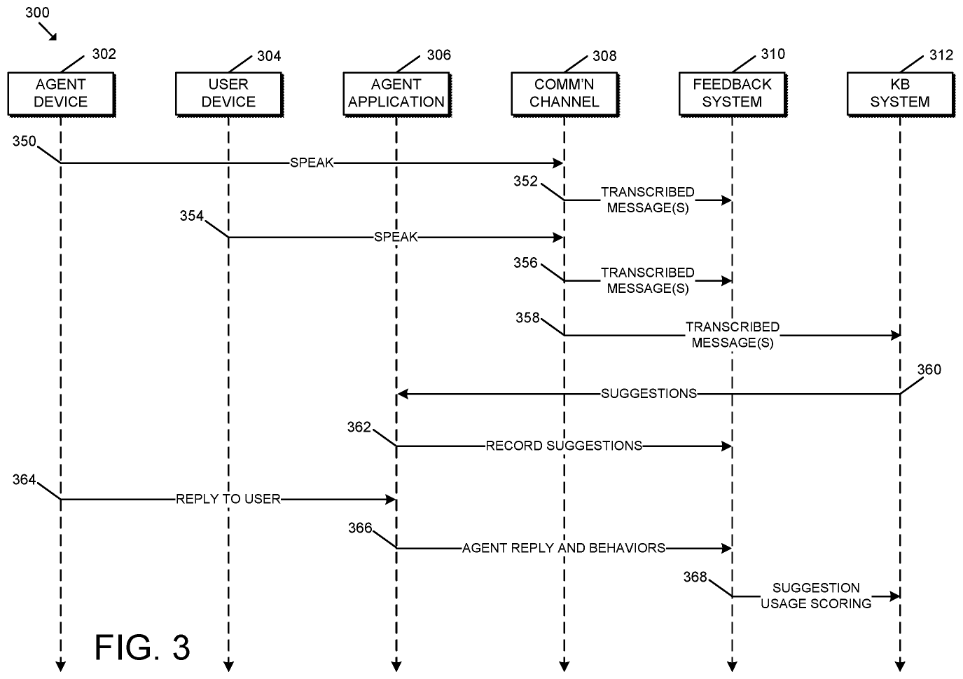

Referring now to FIG. 3, in use, a computing system (e.g., the contact center system 100 and/or computing device 200) may execute a method 300 for providing implicit feedback using multi-factor behavior monitoring. It should be appreciated that the particular blocks of the method 300 are illustrated by way of example, and such blocks may be combined or divided, added or removed, and/or reordered in whole or in part depending on the particular embodiment, unless stated to the contrary.

As shown, the illustrative method 300 involves an agent device 302, a user device 304, an agent application 306, a communication channel 308, an auto-feedback system 310 (or simply “feedback system”), and a knowledge base system 312 (or simply “knowledge base”).

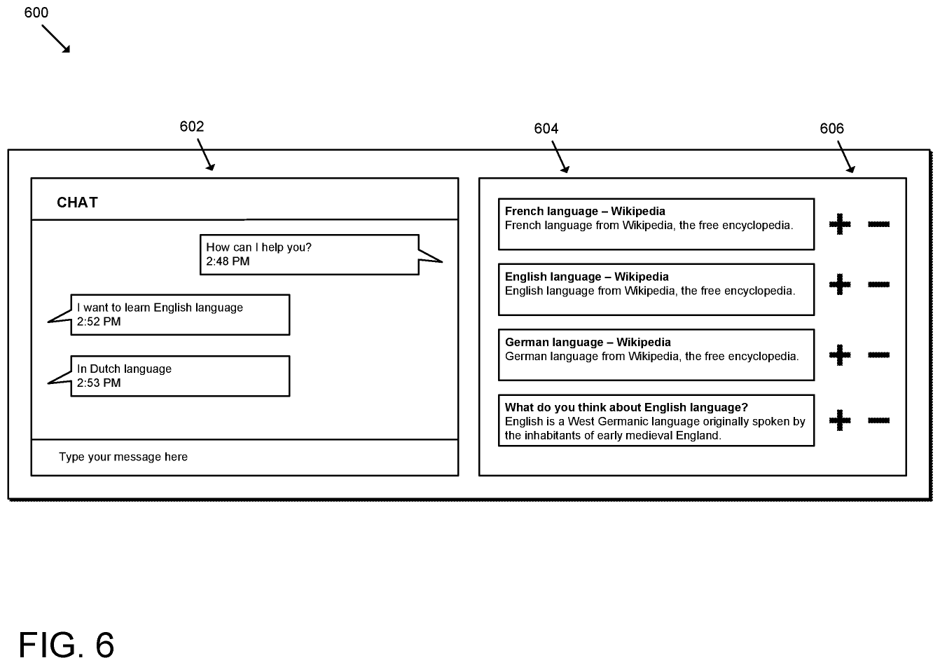

The agent device 302 may be embodied as any type of device or system of the contact center system (e.g., the contact center system 100) that may be used by an agent of the contact center for communication with the user device 304 (e.g., the customer device 102), a cloud-based system, and/or otherwise capable of performing the functions described herein. In some embodiments, the agent device 302 may be embodied as an agent device similar to the agent devices 118A, 118B, 118C described in reference to the contact center system 100 of FIG. 1. The agent device 302 may be configured to execute the agent application 306 to interact with the user and may, for example, display a graphical user interface similar to the graphical user interface 600 depicted in FIG. 6 in order to receive suggestions from the knowledge base system 312. For example, as shown, the graphical user interface 600 may display a chat 602 between the agent (e.g., “How can I help you?”) and the user (e.g., “I want to learn English language”), and suggestions 604 related to the content of the interaction between the agent and user may also be displayed (and with which the agent may interact). Further, in some embodiments, the graphical user interface 600 may include graphical elements 606 (e.g., plus/minus, thumbs up/down, etc.) for the agent to provide manual feedback regarding the helpfulness of the provided suggestions, which may be used to update a knowledge base model (e.g., in addition to autonomous feedback described herein). Further, the agent application 306 may monitor agent interactions with the various elements of the graphical user interface (e.g., cursor position, time focusing on each element, cursor events, element interactions, etc.).

It should be appreciated that the agent application 306 may be embodied as any type of application suitable for performing the functions described herein. In particular, in some embodiments, the agent application 306 may be embodied as a mobile application (e.g., a smartphone application), a desktop application, a cloud-based application, a web application, a thin-client application, and/or another type of application. For example, in some embodiments, application may serve as a client-side interface (e.g., via a web browser) for a web-based application or service.

The user device 304 may be embodied as any type of device (e.g., of a contact center client) capable of executing an application and otherwise performing the functions described herein. For example, in some embodiments, the user device 304 is configured to execute an application to participate in a conversation with a human agent (e.g., via the agent device 302), personal bot, automated agent, chat bot, or other automated system. As such, the user device 304 may have various input/output devices with which a user may interact to provide and receive audio, text, video, and/or other forms of data. It should be appreciated that the application may be embodied as any type of application suitable for performing the functions described herein. In particular, in some embodiments, the application may be embodied as a mobile application (e.g., a smartphone application), desktop application, a cloud-based application, a web application, a thin-client application, and/or another type of application. For example, in some embodiments, application may serve as a client-side interface (e.g., via a web browser) for a web-based application or service.

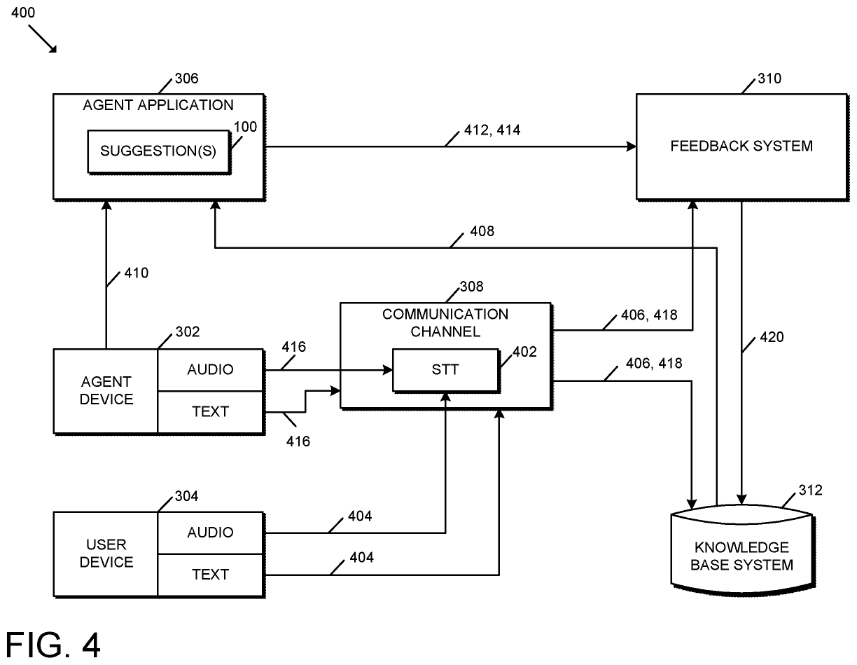

The communication channel 308 may include any one or more devices, systems, and/or components that enable communication between the various devices of the computing system (e.g., within the contact center system 100). For example, within a contact center, interactions between contact center agents and outside entities or users may be conducted over a variety of communication channels, such as, for example, via voice (e.g., telephone calls or voice over IP or VoIP calls), video (e.g., video conferencing), text (e.g., emails and text chat), screen sharing, co-browsing, and/or other communication channels. As shown in FIG. 4, in some embodiments, the communication channel 308 may include a speech-to-text (STT) subsystem 402. For example, where the input is provided as speech from the user (e.g., from audio received by the user device 302) or speech from the agent (e.g., from audio received by the agent device 302), the audio speech may be transcribed into text by a speech-to-text system (such as a large vocabulary continuous speech recognition or LVCSR system) and/or by a natural language processing (NLP) system. It should be appreciated that, in some embodiments, the communication channel 308 may include, involve, or incorporate various devices of the contact center system 100.

The feedback system 310 may be embodied as any device/system or collection of devices/systems configured to perform the functions described herein. For example, the illustrative feedback system 310 is configured to receive a text transcript of a conversation or interaction between an agent and user, a set of suggestions that were provided to the agent based on the interaction, and data indicative of agent interactions with the agent application 306 (or, more specifically, the graphical user interface thereof). The feedback system 310 may evaluate those data by leveraging artificial intelligence (AI) and/or machine learning (ML) techniques to provide feedback regarding the relevance, efficacy, impact, and/or other characteristics regarding the suggestions that were provided to the agent via the agent application 306. For example, the feedback system 310 may leverage machine learning to analyze the data and update/improve the suggestion rankings for subsequent use (e.g., thereby potentially reducing the number of suggestions presented to agents in the future). More specifically, the feedback system 310 may update a knowledge base model of the knowledge base system 312 based on the evaluation of the data using machine learning. In some embodiments, the feedback system 310 may utilize neural network algorithms, regression algorithms, instance-based algorithms, regularization algorithms, decision tree algorithms, Bayesian algorithms, clustering algorithms, association rule learning algorithms, deep learning algorithms, dimensionality reduction algorithms, and/or other suitable machine learning algorithms, techniques, and/or mechanisms.

The knowledge base system 312 may be embodied as any device/system or collection of devices/systems configured to store knowledge base data (e.g., in a database) for providing suggestions to the agent and a knowledge base model on which to base such suggestions, to provide suggestions to the agent based on the content of the conversation/interaction between the agent and user, and to otherwise perform the functions described herein. It should be appreciated that, in some embodiments, the suggestion content and the knowledge base model may be stored in the same data store and/or device/system, whereas in other embodiments, the suggestion content and the knowledge base model may be stored in separate data stores and/or devices/systems. Further, in some embodiments, the knowledge base system 312 may include references and/or pointers to third party data stored in other computing systems that is relevant to the suggestions provided to the agent.

The illustrative method 300 begins with flow 350 in which the agent speaks with (or otherwise communicates with, such as via chat) the user via the agent device 302 and user device 304, respectively, and through the communication channel 308. In flow 352, the agent's audio is transcribed into text using the STT subsystem 402 and transmitted to the feedback system 310. In embodiments in which the agent's input is already in text format (e.g., via chat), the communication channel 308 may normalize the text or simply pass the raw text data to the feedback system 310 depending on the particular embodiment. Inflow 354, the user speaks with (or otherwise communicates with, such as via chat) the agent through the communication channel 308. In flow 356, the user's audio is transcribed into text using the STT subsystem 402 and transmitted to the feedback system 310. Similarly, in embodiments in which the user's input is already in text form, the communication channel 308 may normalize the text or simply pass the raw text data to the feedback system 310 depending on the particular embodiment. In addition to transmitting the transcribed messages to the feedback system 310, it should be appreciated that, in flow 358, the transcribed messages may also be transmitted to the knowledge base system 312. In flow 360, the knowledge base system 312 analyzes the transcription to determine suggestions to provide to the agent (e.g., related topics/articles, related Q&A, etc.), and sends the suggestions to the agent via the agent application 306. In flow 362, the agent application 306 records the suggestions that are presented to the agent to the feedback system 310 (e.g., along with time stamps for when the suggestions were presented and/or other contextual data associated with the presentation of the suggestions). In flow 364, the agent replies to the user's message (e.g., from flow 354), and the agent application 306 monitors agent's interactions with the graphical user interface and/or the suggestion data. In flow 366, the agent application 306 transmits data associated with the agent's reply to the user and the corresponding agent behavior to the feedback system 310 for analysis. In flow 368, the feedback system 310 evaluates the agent's reply and behavior with respect to the various suggestions in order to determine the relevance, efficacy, and/or other characteristics regarding the suggestions that were provided to the agent as assistance. Further, in some embodiments, the feedback system 310 may generate suggestion usage scores and/or otherwise transmit data to the knowledge base system 312 for updating the knowledge base model using machine learning techniques.

Although the flows 350-364 are described in a relatively serial manner, it should be appreciated that various flows of the method 300 may be performed in parallel in some embodiments.

Referring now to FIG. 4, in the illustrative embodiment, a system flow 400 for providing implicit feedback using multi-factor behavior monitoring is shown. The illustrative system flow 400 includes the agent device 302, the user device 304, the agent application 306, the communication channel 308, the feedback system 310, and the knowledge base 312. Additionally, as shown, the illustrative communication channel 308 includes a speech-to-text (STT) subsystem 402.

The illustrative system flow 400 begins with flow 404 in which the user speaks to the agent by asking a question or making a statement (e.g., vocally or using written messages). It should be appreciated that vocal/audio messages may be processed by the STT subsystem 402 of the communication channel 308, whereas text messages may simply be normalized (or passed as raw data), for example. In flow 406, the textual transcript of the message may be transmitted (e.g., in real time or near real time) to the knowledge base system 312 and to the feedback system 310.

In flow 408, the knowledge base system 312 determines/selects suggestions to present to the agent based on the transcript of the conversation/interaction between the agent and the user. In particular, the knowledge base system 312 may analyze the transcript (or the last message(s) of the transcript) based on the knowledge base model and machine learning to identify suggestion content that is related to the transcript. For example, the knowledge base system 312 may find suggestion content associated with related topics, related Q&As, and/or other relevant information from one or more knowledge base data sources. The knowledge base system 312 provides the suggestions to the agent via the agent application 306, which displays the suggestions for the agent (see, for example, the graphical user interface 600 of FIG. 6).

In flow 410, the agent reviews the suggestions and may interact with (or ignore) the suggestions on the graphical user interface and/or other elements of the graphical user interface. For example, the agent interactions monitored by the agent application 306 may include the cursor position, time focusing on each element, cursor events, element interactions, and other agent interactions with the graphical user interface. More specifically, the agent interactions may include mouse over, click to open articles, copy/paste of content, selecting or highlighting text, and/or other interactions. In flow 412, data associated with the displayed suggestions are transmitted to the feedback system 310, and in flow 414, data associated with agent interactions (e.g., clicks, etc.) may be transmitted to the feedback system 310. For example, in some embodiments, the data associated with the displayed suggestions may include times (e.g., time stamps) at which suggestions were displayed to the agent. Similarly, the data associated with the agent interactions may include times (e.g., time stamps) at which the user interactions with the various elements of the graphical user interface occurred.

In flow 416, the agent responds to the user, which may be influenced by the suggestions provided to the agent or respective suggestion content. In flow 418, the agent response message is transmitted to the knowledge base system 312 and the feedback system 310. In flow 420, the feedbacks system 310 evaluates the data indicative of behaviors of the agent (e.g., the agent interactions) with respect to each of the suggestions provided to and/or displayed for the agent using machine learning technologies as described above. In doing so, the feedback system 310 may generate a ranking for each of the suggestions representing, for example, the relevance, efficacy, impact, and/or other characteristic(s) of each suggestion. Further, the evaluation may indicate whether each of the suggestions was used by the agent or not in responding to the user. The feedback system 310 may communicate the results of the evaluation (e.g., the rankings) to the knowledge base system 312 such that the knowledge base model may be updated based on the implicit agent feedback.

Although the flows 404-420 are described in a relatively serial manner, it should be appreciated that various flows of the system flow 400 may be performed in parallel in some embodiments.

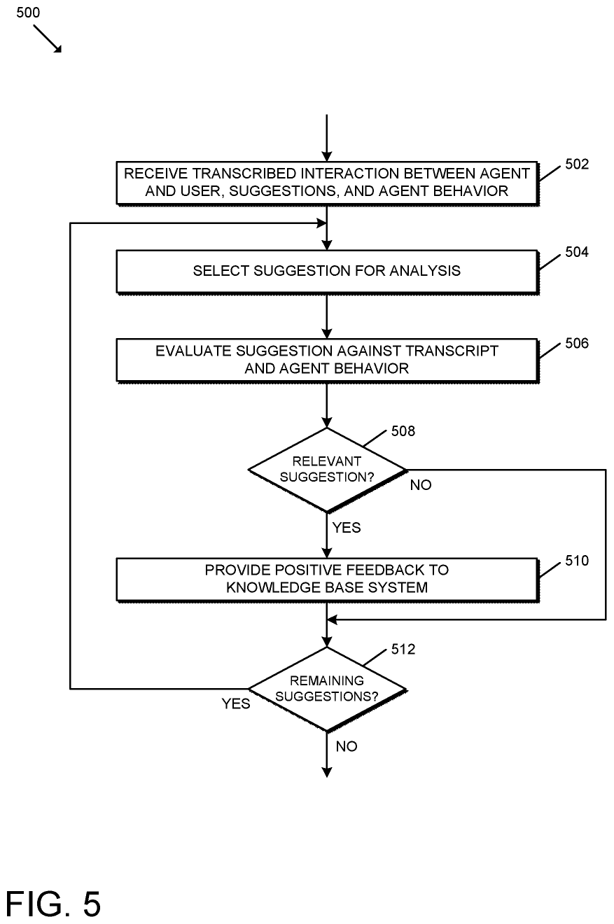

Referring now to FIG. 5, in use, a computing system (e.g., the contact center system 100 and/or computing device 200) may execute a method 500 for providing implicit feedback using multi-factor behavior monitoring. It should be appreciated that the particular blocks of the method 500 are illustrated by way of example, and such blocks may be combined or divided, added or removed, and/or reordered in whole or in part depending on the particular embodiment, unless stated to the contrary.

The illustrative method 500 begins with block 502 in which the computing system receives data associated with a transcribed interaction between the agent and user, suggestions provided to the agent, and agent behavior (e.g., agent interactions). In block 504, the computing system selects one of the suggestions provided to the agent for analysis (e.g., a recently displayed suggestion). In block 506, the computing system evaluates the selected suggestion against the transcript and the agent behavior based on the knowledge base model and machine learning to determine whether the suggestion was relevant. If the computing system determines, in block 508, that the suggestion was relevant, the method 500 advances to block 510 in which the computing system provides positive feedback to the knowledge base system 312 and further advances to block 512. If the computing system determines, in block 508, that the suggestion was not relevant, the method 500 advances to block 512 in which the computing system determines whether any suggestions remain for analysis. If so, the method 500 returns to block 504 in which the computing system selects another suggestion for analysis. In some embodiments, if a particular suggestion is deemed to have not been relevant, the computing system may provide negative feedback to the knowledge base system 312.

Although the blocks 502-512 are described in a relatively serial manner, it should be appreciated that various blocks of the method 500 may be performed in parallel in some embodiments.

What is claimed is:

1. A system for providing implicit feedback using multi-factor behavior monitoring, the system comprising:
a computing system comprising at least one first processor and at least one first memory having a first plurality of instructions stored thereon that, in response to execution by the at least one first processor, causes the computing system to:
receive a transcript of a conversation between an agent and a user;
provide at least one suggestion to the agent via an agent application based on the transcript of the conversation between the agent and the user;
evaluate data indicative of behaviors of the agent with respect to the at least one suggestion using machine learning; and
update a knowledge base model based on the evaluation of the data indicative of behaviors of the agent with respect to the at least one suggestion using machine learning.

2. The system of claim 1, wherein the first plurality of instructions further causes the computing system to analyze the transcript of the conversation between the agent and the user to find suggestion content related to the transcript; and
wherein to provide the at least one suggestion to the agent comprises to provide at least one suggestion to the agent that references the suggestion content related to the transcript.

3. The system of claim 2, further comprising an agent device having a display, at least one second processor, and at least one second memory having a second plurality of instructions stored thereon that, in response to execution by the at least one second processor, causes the agent device to execute the agent application to present the at least one suggestion to the agent on the display via a graphical user interface.

4. The system of claim 3, wherein the second plurality of instructions further causes the agent device to monitor agent interactions with the agent application.

5. The system of claim 4, wherein the agent interactions comprise one or more user interactions with elements of the graphical user interface.

6. The system of claim 5, wherein to evaluate the data indicative of behaviors of the agent with respect to the at least one suggestion using machine learning comprises to evaluate times at which the at least one suggestion were displayed and times of the agent interactions with the agent application.

7. The system of claim 1, wherein to update the knowledge base model based on the evaluation of the data indicative of behaviors of the agents with respect to the at least one suggestion using machine learning comprises to rank each of the at least one suggestion.

8. The system of claim 1, wherein to receive the transcript of the conversation between the agent and the user comprises to receive transcribed messages of the conversation between the agent and the user in real time.

9. A method of providing implicit feedback using multi-factor behavior monitoring, the method comprising:
receiving, by a computing system, a transcript of a conversation between an agent and a user;
providing, by the computing system, at least one suggestion to the agent via an agent application based on the transcript of the conversation between the agent and the user;
evaluating, by the computing system, data indicative of behaviors of the agent with respect to the at least one suggestion using machine learning; and
updating, by the computing system, a knowledge base model based on the evaluation of the data indicative of behaviors of the agent with respect to the at least one suggestion using machine learning.

10. The method of claim 9, further comprising analyzing the transcript of the conversation between the agent and the user to find suggestion content related to the transcript; and
wherein providing the at least one suggestion to the agent comprises providing at least one suggestion to the agent that references the suggestion content related to the transcript.

11. The method of claim 10, wherein the agent application is executed by an agent device of the agent; and
further comprising presenting the at least one suggestion to the agent via a graphical user interface displayed on the agent device via the agent application.

12. The method of claim 11, further comprising monitoring agent interactions with the agent application.

13. The method of claim 12, wherein the agent interactions comprise one or more user interactions with elements of the graphical user interface.

14. The method of claim 13, wherein evaluating the data indicative of behaviors of the agent with respect to the at least one suggestion using machine learning comprises evaluating times at which the at least one suggestion were displayed on the agent device and times of the agent interactions with the agent application.

15. The method of claim 9, wherein updating the knowledge base model based on the evaluation of the data indicative of behaviors of the agents with respect to the at least one suggestion using machine learning comprises ranking each of the at least one suggestion.

16. The method of claim 9, wherein receiving the transcript of the conversation between the agent and the user comprises receiving transcribed messages of the conversation between the agent and the user in real time.

17. One or more non-transitory machine readable storage media comprising a plurality of instructions stored thereon that, in response to execution by a system, causes the system to:
receive a transcript of a conversation between an agent and a user;
provide at least one suggestion to the agent via an agent application based on the transcript of the conversation between the agent and the user;
evaluate data indicative of behaviors of the agent with respect to the at least one suggestion using machine learning; and
update a knowledge base model based on the evaluation of the data indicative of behaviors of the agent with respect to the at least one suggestion using machine learning.

18. The one or more non-transitory machine readable storage media of claim 17, wherein the plurality of instructions further causes the system to analyze the transcript of the conversation between the agent and the user to find suggestion content related to the transcript; and
wherein to provide the at least one suggestion to the agent comprises to provide at least one suggestion to the agent that references the suggestion content related to the transcript.

19. The one or more non-transitory machine readable storage media of claim 17, wherein to evaluate the data indicative of behaviors of the agent with respect to the at least one suggestion using machine learning comprises to evaluate times at which the at least one suggestion were displayed on an agent device and times of the agent interactions with the agent application.

20. The one or more non-transitory machine readable storage media of claim 17, wherein to receive the transcript of the conversation between the agent and the user comprises to receive transcribed messages of the conversation between the agent and the user in real time.
